(19) United States
(12) Patent Application Publication
(10) Pub. No.: US 2026/0054548 A1
(43) Pub. Date: Feb. 26, 2026

(54) SYSTEM FOR AIR-CONDITIONING THE AIR OF A PASSENGER COMPARTMENT OF A MOTOR VEHICLE AS WELL AS METHOD FOR OPERATING THE SYSTEM

(71) Applicant: Hanon Systems, Daejeon (KR)

(72) Inventors: Martin Hötzel, Ratingen (DE); Navid Durrani, Kerpen (DE)

(21) Appl. No.: 19/104,846

(22) PCT Filed: Nov. 10, 2023
(86) PCT No.: PCT/KR2023/018075

§ 371 Date: Feb. 19, 2025

(30) Foreign Application Priority Data
Nov. 24, 2022 (DE) 10 2022 131 139.2
Nov. 6, 2023 (DE) 10 2023 130 532.8

(51) Int. Cl. B60H 1/32; B60H 1/00

(52) U.S. Cl. CPC B60H 1/3228; B60H 1/3205; B60H 1/3227; B60H 1/00278; B60H 2001/00307

(57) ABSTRACT

A system for air-conditioning the air of a passenger compartment of a motor vehicle, having a refrigerant circuit with a compressor, a first refrigerant/air heat exchanger operable as a condenser/gas cooler for heating the incoming air of the passenger compartment, a refrigerant path with a second refrigerant/air heat exchanger operable as a condenser/gas cooler or an evaporator for heat exchange with the ambient air with an upstream first expansion member and a third refrigerant/air heat exchanger operable as an evaporator for conditioning the incoming air of the passenger compartment with an upstream second expansion member and a refrigerant path with a refrigerant/coolant heat exchanger operable as an evaporator for heat exchange between a coolant for controlling the temperature of at least one component of a drive train of the motor vehicle and the refrigerant with an upstream third expansion member.

### CROSS REFERENCE TO RELATED PATENT APPLICATIONS

This is a U.S. national phase patent application of PCT/KR2023/018075 filed Nov. 10, 2023, which claims the benefit of and priority to German Patent Application No. DE 10 2023 130 532.8, filed on Nov. 6, 2023, and German Patent Application No. DE 10 2022 131 139.2, filed on Nov. 24, 2022, the entire contents of each of which are incorporated herein by reference for all purposes.

### TECHNICAL FIELD

The invention relates to a system for air-conditioning the air of a passenger compartment of a motor vehicle. The system has a refrigerant circuit with a compressor, a first refrigerant/air heat exchanger, which can be operated as a condenser/gas cooler, for heating the incoming air of the passenger compartment, a refrigerant path with a second refrigerant/air heat exchanger, which can be operated as a condenser/gas cooler or evaporator, for heat exchange with the ambient air and a third refrigerant/air heat exchanger, which can be operated as an evaporator, for conditioning the incoming air of the passenger compartment and a refrigerant path with a refrigerant/coolant heat exchanger, which can be operated as an evaporator, for heat exchange between a coolant for controlling the temperature of at least one component of a drive train of the motor vehicle and the refrigerant. The invention also relates to methods for operating the system.

Motor vehicles with different drive concepts are known from the state of the art. The concepts are based on drives by means of a combustion engine, an electric motor or a combination of both motor types. Consequently, motor vehicles with a combination of an internal combustion engine and an electric motor drive have a hybrid drive so that the motor vehicle can be driven electrically, electrically/with an internal combustion engine or with an internal combustion engine as required.

### BACKGROUND ART

As is known, electric vehicles and vehicles with a hybrid drive and fuel cell vehicles and vehicles driven with an internal combustion engine with high energetic efficiency do not create enough waste heat in order to heat the passenger compartment at low ambient temperatures corresponding to the requirements of thermal comfort.

A first, cost-efficient and installation space-saving solution for heating the incoming air for the passenger compartment is an electric heater, which is, for example, formed as a PTC-heater for heating the incoming air flowing into the passenger compartment, in connection with a refrigerant circuit for exclusively cooling and de-humidifying the incoming air. However, systems provided with a PTC-heater have a high energy consumption at low outlet temperatures of the incoming air for heating the passenger compartment. The electric additional heater, which cannot be operated in an energy-efficient manner, shortens the reach of battery-electrically driven motor vehicles.

A second, more energy-efficient solution for heating the incoming air for the passenger compartment is an air-conditioning system with a heat pump function which uses different heat sources and heat sinks, but requires a significantly larger installation space than the first solution with an electric heater.

When operating the air-conditioning system of a motor vehicle with a heat pump function in a cooling mode, in particular when operating a refrigerant circuit of the air-conditioning system with an evaporator and a condenser/gas cooler of the refrigerant, the heat required for the evaporation of the refrigerant is absorbed at a lower temperature level and pressure level in the evaporator from the incoming air to the passenger compartment or from a coolant circuit. The coolant circuit can, for example, serve to control the temperature, specifically to cool electric components, such as a traction battery, of an electrically driven motor vehicle. In the condenser/gas cooler, the heat absorbed by the coolant can be transferred to the environment at a higher temperature level and pressure level.

When operating the air-conditioning system or the refrigerant circuit of the air-conditioning system with a heat pump system in a heating mode, the heat required for the evaporation of the refrigerant is absorbed from a heat source in the evaporator at the low temperature level and pressure level. The ambient air can be used as a heat source. The heat absorbed from the ambient air for the evaporation of the refrigerant can either be transferred in a refrigerant/air heat exchanger directly to the refrigerant or first to a coolant circulating in a coolant circuit and then in a refrigerant/coolant heat exchanger from the coolant to the refrigerant.

The performance and the energetic efficiency of the air-conditioning system with a heat pump function in particular depends on the fact which heat amount at which temperature level is available for the evaporation of the refrigerant. At low ambient temperatures, the heat absorption from the ambient air is also limited due to the required avoidance of the freezing of the surface of the heat exchanger charged with the ambient air. The freezing of the surface of the heat exchanger decreases the heat transfer between the ambient air and the surface of the heat exchanger and thus the heat exchange from the ambient air to the refrigerant, which reduces the heat transferred from the ambient air to the refrigerant and the energetic efficiency of the complete air-conditioning system.

Furthermore, the maximum temperature difference between the temperature of the ambient air flowing into the heat exchanger and the temperature of the refrigerant is limited. The maximum temperature difference, on the other hand, has a limiting effect on the heat which can be transferred from the ambient air to the refrigerant.

At very low temperatures of the ambient air, the freezing of the surface of the heat exchanger charged with the ambient air cannot be avoided so that the incoming air for the passenger compartment cannot be heated sufficiently if exclusively the ambient air is used as a heat source. In order to sufficiently heat the incoming air for the passenger compartment at the very low temperatures of the ambient air, the refrigerant circuit, at the low pressure side, is formed with a refrigerant/coolant heat exchanger as a thermal connection of the refrigerant circuit to a coolant circuit, which is formed for controlling the temperature of components of the electric drive train of the motor vehicle. The coolant takes up, for example, the waste heat of at least one component of the electric drive train, such as battery cells of a high voltage battery. The refrigerant/coolant heat exchanger, also referred to as chiller, enables an additional possible transfer of heat from coolant circulating in the coolant circuit, in particular a water/glycol mixture, to the refrigerant circulating in the refrigerant circuit. The heat transferred from the components of the electric drive train to the coolant can also be directly transferred to the environment, in particular the ambient air, in a so-called low temperature heat exchanger of the coolant circuit without operating the refrigerant circuit.

The design of the air-conditioning systems known from the state of the art with a heat pump function for heat distribution within battery-electrically driven motor vehicles is very complex and requires a plurality of components both at the refrigerant side and at the coolant side and the air side, which causes high system costs.

Motor vehicles with a large-volume passenger compartment and thus a large amount of incoming air to be air-conditioned, such as sports and utility vehicles, or off-road limousines or SUVs, people transporters and large-volume limousines, shortly referred to as VAN, require such a high performance for heating and cooling which is difficult to provide with air-conditioning systems with a heat pump function for other motor vehicles. Especially, there is a lack of sufficient comfort for the passengers in the rear section of the passenger compartment.

Conventional simply structured air-conditioning systems permit, for example, an uncomplicated integration of one or more rear air-conditioners, but are only operable in an energetically inefficient manner. With air-conditioning systems known from the state of the art, which are operable in a more energy-efficient manner, in particular with a heat exchanger charged with ambient air, the integration of one or more rear air-conditioners is not easily possible. However, such more efficiently operable air-conditioning systems do not have any refrigerant line in which correctly conditioned refrigerant for the additional rear air-conditioners is always provided.

DE 10 2021 131 215 A1 reveals a heat pump arrangement for battery-operated vehicles with a refrigerant circuit and coolant circuits. The refrigerant circuit has a compressor, a heating condenser, a first expansion valve, an ambient heat exchanger, at least one evaporator with an associated second expansion valve and a 3/2 way refrigerant valve arranged in parallel to the evaporator and with an expansion function as well as a chiller and a refrigerant path formed as a bypass around the chiller. Between the heating condenser and the first expansion valve, a refrigerant path formed as a bypass around the ambient heat exchanger with a third expansion valve branches off, which opens upstream of the chiller in the flow direction.

### SUMMARY

The object of the invention is the provision of a system for air-conditioning the air of an in particular large-volume passenger compartment, specifically for motor vehicles with a purely electric drive or a combined electric and internal combustion engine drive. The system is to enable a comfortable air-conditioning possible of the passenger compartment with maximum energetic efficiency. The system should be operable in a reliable manner both a lower and higher temperatures of the ambient air. The production, maintenance and operation costs and the required installation space of the system should be at a minimum.

The object is achieved by the subject matters having the features as shown and described herein.

The object is achieved with a system according to the invention for air-conditioning the air of a passenger compartment, in particular also for the heat exchange with components of an electric drive train of a motor vehicle. The system has a refrigerant circuit with a compressor, a first refrigerant/air heat exchanger operable as a condenser/gas cooler for heating the incoming air of the passenger compartment, a refrigerant path with a second refrigerant/air heat exchanger operable as a condenser/gas cooler or an evaporator for heat exchange with the ambient air with an upstream first expansion member and a third refrigerant/air heat exchanger operable as an evaporator for conditioning the incoming air of the passenger compartment with an upstream second expansion member and a refrigerant path with a first refrigerant/coolant heat exchanger operable as an evaporator for heat exchange between a coolant for controlling the temperature of at least one component of a preferably electric drive train of the motor vehicle and the refrigerant with an upstream third expansion member.

The refrigerant path with the second refrigerant/air heat exchanger and the third refrigerant/air heat exchanger and the refrigerant path with the refrigerant/coolant heat exchanger operable as an evaporator respectively extend from a branching point to an opening point. The refrigerant paths can be charged with refrigerant independently from one another and in parallel to one another.

If the liquefaction of the refrigerant occurs during sub-critical operation, such as with the refrigerant R134a or in certain ambient conditions with carbon dioxide, for example, the heat exchangers are referred to as a condenser. Part of the heat transfer takes place at a constant temperature. During supercritical operation or supercritical heat release in the heat exchanger, the temperature of the refrigerant decreases continuously. In this case, the heat exchanger is also referred to as gas cooler. Supercritical operation may occur under certain ambient conditions or modes of operation of the refrigerant circuit, for example, with the refrigerant carbon dioxide.

An electric motor, an internal charger, a transformer or an inverter, for example, are understood to be components of the electric drive train of the motor vehicle. A battery, in particular a high voltage battery, can also be among the components of the electric drive train.

According to the concept of the invention, the refrigerant circuit has a connection point with a first port, a second port and a third port. The first port is arranged between the first refrigerant/air heat exchanger and the first expansion member of the second refrigerant/air heat exchanger and the third port is arranged between the second refrigerant/air heat exchanger and the second expansion member of the third refrigerant/air heat exchanger. A refrigerant path extends from the third port of the connection point to an opening point, in which at least one refrigerant/air heat exchanger operable as an evaporator for conditioning the incoming air of the passenger compartment with an upstream expansion member is formed. The opening point is arranged upstream of the compressor in the flow direction of the refrigerant.

According to a further development of the invention, the refrigerant path extending from the third port of the connection point to the opening point has a first flow path and a second flow path which respectively extend from a branching point to an opening point and can be charged with refrigerant independently from one another and in parallel to one another. The first flow path is formed with a fourth refrigerant/air heat exchanger operable as an evaporator with an upstream fourth expansion member and the second flow path is formed with a fifth refrigerant/air heat exchanger, which can be operated as an evaporator, with an upstream fifth expansion member.

According to a preferred design of the invention, the branching point of the refrigerant paths, with the second refrigerant/air heat exchanger and the third refrigerant/air heat exchanger on the one hand and the refrigerant/coolant heat exchanger operable as an evaporator on the other hand, is arranged between the first refrigerant/air heat exchanger and the first expansion member of the second refrigerant/air heat exchanger. The opening point of the refrigerant paths with the second refrigerant/air heat exchanger and the third refrigerant/air heat exchanger and the refrigerant/coolant heat exchanger operable as an evaporator is preferably arranged in the flow direction of the refrigerant upstream of the compressor.

According to an advantageous design of the invention, the connection point is formed as a 3/2 way valve, wherein the first port is an inlet, the second port is an outlet and the third port is an inlet and an outlet. The 3/2 way valve can be connected to an outlet of the first refrigerant/air heat exchanger for heating the incoming air of the passenger compartment via the first port and to an outlet of the second refrigerant/air heat exchanger for heat exchange with the ambient air via the third port. The 3/2 way valve advantageously has a high internal tightness.

According to a further preferred design of the invention, the refrigerant circuit has an accumulator which is arranged upstream of the compressor in the flow direction of the refrigerant so that the refrigerant flowing out of the accumulator is directly drawn in by the compressor. The opening point of the refrigerant path extending from the third port of the connection point can either be arranged between the third refrigerant/air heat exchanger and the compressor, in particular in the flow direction of the refrigerant upstream of the accumulator, or between the accumulator and the compressor.

A special advantage of the invention is that the refrigerant circuit has a connection point formed as a 3/2 way valve with an expansion function and with a first port, a second port and a third port. In particular, the first port is formed as an inlet and the second port and the third port are respectively formed as an outlet and the expansion function is formed between the first port and the third port of the 3/2 way valve. The 3/2 way valve with an expansion function can be connected to a branching point arranged between the second refrigerant/air heat exchanger for heat exchange with the ambient air and the second expansion member of the third refrigerant/air heat exchanger for conditioning the incoming air of the passenger compartment via the first port, to an opening point arranged between the third refrigerant/air heat exchanger and the compressor via the second port and to an opening point arranged between the third expansion member and the refrigerant/coolant heat exchanger operable as an evaporator via the third port.

According to a further development of the invention, the system has an air-conditioner with at least two air flow channels. The third refrigerant/air heat exchanger operable as an evaporator for conditioning the incoming air of the passenger compartment and the first refrigerant/air heat exchanger operable as a condenser/gas cooler for heating the incoming air of the passenger compartment are arranged in the flow direction of the incoming air one after the other preferably within a first air flow channel which opens into the passenger compartment in a front section of the passenger compartment. The fourth refrigerant/air heat exchanger for conditioning the incoming air of the passenger compartment, operable as an evaporator, is preferably arranged within a second air flow channel which opens into the passenger compartment in a rear section of the passenger compartment. The fifth refrigerant/air heat exchanger for conditioning the incoming air of the passenger compartment, operable as an evaporator, can be arranged within a third air flow channel which opens into the passenger compartment in a rear section of the passenger compartment.

It is of particular advantage that within the respective air flow channel in the flow direction of the incoming air downstream of the refrigerant/air heat exchanger operable as an evaporator, a respective thermal heat exchanger for heating the incoming air is provided, which can be formed as a coolant/air heat exchanger or as an electric PTC heater.

According to a further advantageous design of the invention, the refrigerant circuit has a refrigerant/coolant heat exchanger operable as a condenser/gas cooler and a branching point formed as a 3/2 way valve with a first port, a second port and a third port. In particular, the first port is formed as an inlet and the second port and the third port are respectively formed as an outlet.

The 3/2 way valve can be connected to an outlet of the compressor via the first port, to the refrigerant/coolant heat exchanger operable as a condenser/gas cooler via the second port and to an opening point arranged in the flow direction of the refrigerant upstream of the first refrigerant/air heat exchanger via the third port.

The refrigerant/coolant heat exchanger operable as a condenser/gas cooler is preferably arranged within a flow path extending between the second port of the 3/2 way valve to the opening point arranged upstream of the first refrigerant/air heat exchanger.

The 3/2 way valves are preferably driven electrically. The expansion members are respectively advantageously formed as an expansion valve.

The refrigerant/coolant heat exchanger operable as an evaporator and the refrigerant/coolant heat exchanger operable as a condenser/gas cooler can be formed as components of a common coolant circuit or of separate coolant circuits. The partial coolant circuits can also be operated together as a coolant circuit or independently and fluidly fully separated from one another, wherein a complete partial amount of the coolant is associated with each of the partial refrigerant circuits.

The object is also achieved with a first method according to the invention for operating the above-mentioned system for air-conditioning the air of a passenger compartment of a motor vehicle in a refrigeration plant mode for conditioning, in particular for cooling and/or de-humidifying the incoming air of the passenger compartment. The method has the following steps:
guiding the refrigerant circulating in the refrigerant circuit and flowing out of the compressor at high pressure level through the first expansion member to the second refrigerant/air heat exchanger operated as a condenser/gas cooler and transferring heat from the refrigerant at the high pressure level to ambient air, wherein the first expansion member is fully opened and the refrigerant, when flowing through the second refrigerant/air heat exchanger, is fully liquefied and supercooled or cooled down,
guiding the refrigerant flowing out of the second refrigerant/air heat exchanger to the connection point formed as a 3/2 way valve, and
dividing the refrigerant into a partial mass flow through the third refrigerant/air heat exchanger operated as an evaporator with an upstream second expansion member and a partial mass flow through the refrigerant path extending from the third port of the 3/2 way valve to the opening point with the at least one refrigerant/air heat exchanger operated as an evaporator with an upstream expansion member,
relaxing the partial mass flows to a low pressure level when flowing through the expansion members and guiding the partial mass flows to the refrigerant/air heat exchangers operated as an evaporator,
evaporating and optionally overheating the partial mass flows when flowing through the refrigerant/air heat exchangers operated as an evaporator, wherein respective heat is transferred from the incoming air of the passenger compartment guided through an air flow channel to the refrigerant, wherein the incoming air is cooled down and/or de-humidified and respectively flows out of the air flow channel into a front section of the passenger compartment and a rear section of the passenger compartment, and
mixing the partial mass flows of the refrigerant in the flow direction of the refrigerant upstream of the compressor and drawing the refrigerant through the compressor.

According to a further development of the invention, the partial mass flow of the refrigerant guided through the refrigerant path extending from the third port of the 3/2 way valve to the opening point is divided into a partial mass flow through a first flow path and a partial mass flow through a second flow path. The partial mass flow flowing through the first flow path and the partial mass flow flowing through the second flow path are respectively relaxed to the low pressure level when flowing through the expansion member and evaporated and optionally overheated when flowing through the refrigerant/air heat exchanger. Heat is respectively transferred from the incoming air of the passenger compartment guided through one of the air flow channels to the refrigerant, wherein the incoming air is respectively cooled down and/or de-humidified and flows out of the air flow channel into the rear section of the passenger compartment. The partial mass flows of the vaporous and optionally overheated refrigerant are then mixed with one another.

According to a preferred design of the invention, the refrigerant flowing out of the second refrigerant/air heat exchanger is divided into a partial mass flow to the connection point formed as a 3/2 way valve and a partial mass flow to the 3/2 way valve with an expansion function.

When flowing through the 3/2 way valve, the partial mass flow guided to the 3/2 way valve with expansion function is relaxed to the low pressure level, and when flowing through the refrigerant/coolant heat exchanger operated as an evaporator, is evaporated and optionally overheated. In doing so, heat is transferred from a coolant circulating in a coolant circuit to the refrigerant circulating in the refrigerant circuit. The partial mass flows of the refrigerant are mixed with one another before being sucked in by the compressor.

The cooled down coolant is advantageously conveyed to at least one component of the drive train and thus the component is cooled.

The refrigerant flowing out of the compressor at high pressure level can be guided to a refrigerant/coolant heat exchanger operated as a condenser/gas cooler. When flowing through the refrigerant/coolant heat exchanger, the refrigerant is preferably at least de-heated and partially liquefied or cooled down. In doing so, the heat is transferred from the refrigerant to the coolant circulating in a coolant circuit.

The object is also achieved with a second method according to the invention for operating the above-mentioned system for air-conditioning the air of a passenger compartment of a motor vehicle in a post-heating mode for conditioning, in particular for de-humidifying and optionally cooling and post-heating the incoming air of the passenger compartment. The method has the following steps:
guiding the refrigerant circulating in the refrigerant circuit and flowing out of the compressor at high pressure level to a refrigerant/coolant heat exchanger operated as a condenser/gas cooler and transferring heat from the refrigerant to a coolant circulating in a coolant circuit, wherein the refrigerant, when flowing through the refrigerant/coolant heat exchanger (28), is at least de-heated and partially liquefied or cooled down, wherein the heated coolant is guided through thermal heat exchangers charged with the incoming air for heating the previously de-humidified and optionally cooled down incoming air for a rear section of the passenger compartment,
guiding the refrigerant flowing out of the refrigerant/coolant heat exchanger operated as a condenser/gas cooler to the first refrigerant/air heat exchanger and transferring heat from the refrigerant at the high pressure level to the incoming air for a front section of the passenger compartment, wherein the refrigerant, when flowing through the first refrigerant/air heat exchanger, is fully liquefied and supercooled or cooled down and the previously de-humidified and optionally cooled down incoming air is heated,
guiding the refrigerant flowing out of the first refrigerant/air heat exchanger to the connection point formed as a 3/2 way valve, and
dividing the refrigerant into a partial mass flow through the second refrigerant/air heat exchanger operated as an evaporator with an upstream first expansion member and a partial mass flow through the refrigerant path extending from the third port of the connection point formed as a 3/2 way valve to the opening point with the at least one refrigerant/air heat exchanger operated as an evaporator with an upstream expansion member,
relaxing the partial mass flow of the refrigerant guided to the second refrigerant/air heat exchanger to a medium pressure level or a low pressure level when flowing through the first expansion member and guiding the partial mass flow through the second refrigerant/air heat exchanger operated as an evaporator, wherein the refrigerant is at least partially evaporated and the heat is transferred from ambient air to the refrigerant, and guiding the partial mass flow of the refrigerant flowing out of the second refrigerant/air heat exchanger to the third refrigerant/air heat exchanger operated as an evaporator with an upstream second expansion member and relaxing the partial mass flow to a low pressure level when flowing through the second expansion member and guiding the partial mass flow to the third refrigerant/air heat exchanger operated as an evaporator,
relaxing the partial mass flow of the refrigerant guided through the refrigerant path extending from the third port of the connection point formed as a 3/2 way valve to the opening point with the at least one refrigerant/air heat exchanger operated as an evaporator with an upstream expansion member to the low pressure level when flowing through the expansion member and guiding the partial mass flow to the refrigerant/air heat exchanger operated as an evaporator,
evaporating and optionally overheating the partial mass flows of the refrigerant when flowing through the refrigerant/air heat exchangers operated as an evaporator, wherein respective heat is transferred from the incoming air of the passenger compartment guided through an air flow channel to the refrigerant, wherein the incoming air is cooled down and/or de-humidified, wherein the incoming air flowing through the first refrigerant/air heat exchanger is heated and flows out into the front section of the passenger compartment and the incoming air flowing through a thermal heat exchanger is heated and flows out into the rear section of the passenger compartment, and
mixing the partial mass flows of the refrigerant and drawing the refrigerant through the compressor.

According to a further development of the invention, the partial mass flow of the refrigerant guided through the refrigerant path extending from the third port of the connection point formed as a 3/2 way valve to the opening point is divided into a partial mass flow through a first flow path and a partial mass flow through a second flow path. The partial mass flow flowing through the first flow path and the partial mass flow flowing through the second flow path are respectively relaxed to the low pressure level when flowing through the expansion member and evaporated and optionally overheated when flowing through the refrigerant/air heat exchanger. Heat is respectively transferred from the incoming air of the passenger compartment guided through one of the air flow channels to the refrigerant, wherein the incoming air is respectively cooled down and/or de-humidified and, when flowing through the thermal heat exchanger, is heated and flows out of the air flow channel into the rear section of the passenger compartment. The partial mass flows of the vaporous and optionally overheated refrigerant are mixed with one another.

According to an advantageous design of the invention, the partial mass flow of the refrigerant guided to the second refrigerant/air heat exchanger operated as an evaporator with an upstream first expansion member is divided into a partial mass flow of the first expansion member and a partial mass flow to the refrigerant/coolant heat exchanger operated as an evaporator with an upstream third expansion member. The partial mass flow guided to the refrigerant/coolant heat exchanger operated as an evaporator is relaxed to the low pressure level when flowing through the third expansion member and evaporated and optionally overheated when flowing through the refrigerant/coolant heat exchanger. In doing so, heat is transferred from the coolant circulating in a coolant circuit to the refrigerant circulating in the refrigerant circuit. The partial mass flows of the refrigerant are mixed with one another before being sucked in by the compressor.

The cooled down coolant is advantageously conveyed to at least one component of the drive train and the component is cooled.

The advantageous design of the invention enables the use of the system in motor vehicles with an electric motor drive or a hybrid drive of an electric motor and an internal combustion engine.

The system according to the invention can be operated advantageously such that the refrigerant is always guided to expansion members upstream of refrigerant/air heat exchangers in particular operated as an evaporator in an optimum condition in order to de-humidify or dry and cool the incoming air of the passenger compartment. The refrigerant rests against the expansion members at a high pressure level, in particular at a high pressure level or a medium pressure level, advantageously mostly in a supercooled or at least fully or partially liquid condition. The refrigerant/air heat exchangers with the upstream expansion elements which are specifically arranged in an air flow channel or at least two air flow channels, which respectively open into the rear section of the passenger compartment, operated as an evaporator, can, depending on the requirement and the operation mode, be connected to the outlet of the first refrigerant/air heat exchanger operable as a condenser/gas cooler for heating the incoming air of the passenger compartment or to the outlet of the second refrigerant/air heat exchanger for heat exchange with the ambient air.

In summary, the system according to the invention with an integrated heat pump functionality, in particular for exclusively electrically driven or hybrid-driven motor vehicles with an internal combustion engine, has several advantages:
fulfils all requirements of heat management of an electric vehicle in a very broad range of the ambient temperature with the air-conditioning of the air of a passenger compartment through cooling, de-humidifying and heating and controlling the temperature, in particular cooling or heating the battery and cooling of components of the drive train,
high degree of waste heat recovery, thus energy-efficient heating of the incoming air for the passenger compartment through use of waste heat of the refrigerant circuit and recovery of heat from components of the electric drive train, thereby maximum energetic efficiency during operation with high degree of waste heat utilization with high flexibility and functionality, in particular high energetic efficiency during operation in a temperature range of the environment between 5° C. and 35° C., thus minimum energy consumption, specifically minimum consumption of electric energy, which, for example, maximizes the reach of the electrically driven motor vehicle or reduces the size of the battery compared to a motor vehicle with similar reach,
maximum comfort in the entire passenger compartment also with a large air volume, such as motor vehicles for more than five passengers,
compact design with small complexity both on the refrigerant side and on the air-side, in particular through the use of suitable refrigerant lines with corresponding flow cross-sections for a minimum total refrigerant need of the system,
low costs for production and maintenance as well as during operation, in particular also through the use of simple, cost-effective expansion members associated with the refrigerant/air heat exchangers.

The system, in particular the refrigerant circuit, is independent of the used refrigerant and therefore also suited for R134a, R1234yf, R290 or other refrigerants.

### DESCRIPTION OF DRAWINGS

Further details, features, and advantages of designs of the invention will become apparent from the following description of exemplary embodiments with reference to the accompanying drawings. In the drawings:

FIG. 1A: a first system for air-conditioning the air of a passenger compartment of a motor vehicle with a first refrigerant circuit and

FIG. 1B: a second system for air-conditioning the air of a passenger compartment of a motor vehicle with a second refrigerant circuit,

FIG. 2: the first system of FIG. 1A during the operation of the refrigerant circuit in a first refrigeration plant mode,

FIG. 3: the first system of FIG. 1A during the operation of the refrigerant circuit in a second refrigeration plant mode,

FIG. 4: the first system of FIG. 1A during the operation of the refrigerant circuit in a post-heating mode, and

FIG. 5: the first system of FIG. 1A during the operation of the refrigerant circuit in a first heating mode.

### DESCRIPTION OF AN EMBODIMENT

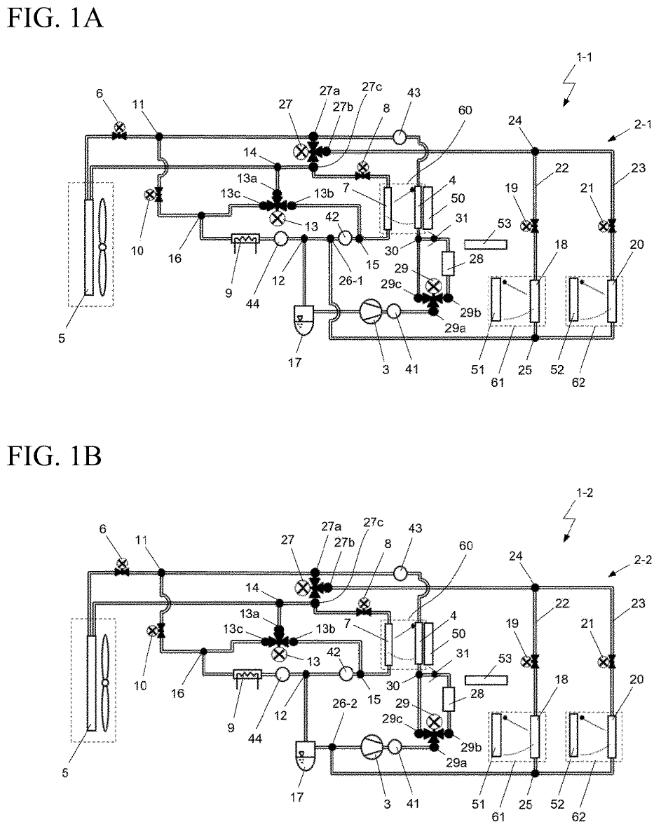

FIGS. 1A and 1B respectively show a system 1-1, 1-2 for air-conditioning the air of a passenger compartment of a motor vehicle with a refrigerant circuit 2-1, 2-2.

The refrigerant circuit 2-1, 2-2 respectively represented with a double line has, in the flow direction of the refrigerant, a compressor 3 for drawing in and compressing the refrigerant, a first refrigerant/air heat exchanger 4 operated as a condenser/gas cooler for heating the incoming air of the passenger compartment, a second refrigerant/air heat exchanger 5 for heat exchange with the ambient air and a first expansion member 6 upstream of the second refrigerant/air heat exchanger 5, in particular an expansion valve. The refrigerant circuit 2-1, 2-2 is respectively also formed with a third refrigerant/air heat exchanger 7 operated as an evaporator for cooling down or de-humidifying the incoming air of the passenger compartment and a second expansion member 8 upstream of the third refrigerant/air heat exchanger 7, in particular an expansion valve. The outlet of the third refrigerant air heat exchanger 7 is connected to the compressor 3. The refrigerant circuit 2-1, 2-2 is closed.

The third refrigerant/air heat exchanger 7 operated as an evaporator for cooling down or de-humidifying the incoming air of the passenger compartment and the first refrigerant/air heat exchanger 4 operated as a condenser/gas cooler for heating the incoming air of the passenger compartment are arranged one after the other in the stated order in the flow direction of the incoming air within a first air flow channel 60 of an air-conditioner of the motor vehicle. The incoming air guided through the first air flow channel 60 can in particular be introduced into the passenger compartment in the front section of the passenger compartment.

With the first expansion member 6 arranged between the first refrigerant/air heat exchanger 4, through which the refrigerant flows at a high pressure level, and the second refrigerant/air heat exchanger 5, the pressure level of the refrigerant in the second refrigerant/air heat exchanger 5 can be set to a pressure level in the range from high pressure level up to a low pressure level for heat exchange from the refrigerant to the ambient air when operating in a refrigeration plant mode or for heat exchange from the ambient air to the refrigerant when operating in a heating mode. Thus, the system can be operated with three different pressure levels, wherein a medium pressure level can vary between the high pressure level and the low pressure level, also referred to as suction pressure level of the compressor 3. By varying the medium pressure level of the refrigerant in the second refrigerant/air heat exchanger 5, for example, the heat dissipation from the refrigerant to the ambient air can be limited or regulated when operating the system 1-1, 1-2 in the refrigeration plant mode, on the one hand, and on the other hand, when operating the system 1-1, 1-2 in a heat mode, the heat absorption from the ambient air can be regulated.

The refrigerant circuit 2-1, 2-2 respectively also has a first refrigerant/coolant heat exchanger 9 operated as an evaporator with a third expansion member 10 upstream of the first refrigerant/coolant heat exchanger 9 in the flow direction of the refrigerant as a thermal connection with at least one refrigerant circuit. The first refrigerant/coolant heat exchanger 9 and the third expansion member 10, in particular an expansion valve, are arranged within a refrigerant path which extends from a first branching point 11 to a first opening point 12. The first branching point 11 is arranged between the first refrigerant/air heat exchanger 4 and the first expansion member 6 of the second refrigerant/air heat exchanger 5, while the first opening point 12 is arranged between the third refrigerant/air heat exchanger 7 and the compressor 3.

Thus, the first refrigerant/air heat exchanger 4, as an alternative to the flow through the second refrigerant/air heat exchanger 5 and the third refrigerant/air heat exchanger 7 operated as an evaporator with the second expansion member 8, is also connected to the compressor 3 via the third expansion member 10 and the first refrigerant/coolant heat exchanger 9. The refrigerant path with the first refrigerant/coolant heat exchanger 9 and the third expansion member 10 is formed in parallel to a refrigerant path with the second refrigerant/air heat exchanger 5 and the third refrigerant/air heat exchanger 7 with the respective upstream expansion members 6, 8.

Furthermore, the outlet of the second refrigerant/air heat exchanger 5 is coupled both to the second expansion member 8 of the third refrigerant/air heat exchanger 7 and to a first 3/2 way valve 13 with an expansion function. The first 3/2 way valve 13 has three ports 13a, 13b, 13c. A first port 13a is formed as an inlet and a second port 13b and a third port 13c are respectively formed as an outlet of the first 3/2 way valve 13. The expansion function of the first 3/2 way valve 13 is provided when flowing from the first port 13a to the third port 13c. The first 3/2 way valve 13 is connected to the second refrigerant/air heat exchanger 5 via the first port 13a, is connected to the compressor 3 via the second port 13b and is connected to the first refrigerant/coolant heat exchanger 9 via the third port 13c.

The first port 13a of the first 3/2 way valve 13 is connected to a second branching point 14 as an inlet, which is arranged between the second refrigerant/air heat exchanger 5 and the second expansion member 8 of the third refrigerant/air heat exchanger 7 operated as an evaporator. The second port 13b of the first 3/2 way valve 13 is connected to a second opening point 15 as an outlet, which is formed between the third refrigerant/air heat exchanger 7 and the first opening point 12 or the compressor 3. The third port 13c of the first 3/2 way valve 13 is connected to a third opening point 16 as an outlet, which is arranged between the third expansion member 10 of the first refrigerant/coolant heat exchanger 9 and the first refrigerant/coolant heat exchanger 9 operated as an evaporator.

While thus the first 3/2 way valve 13 can be fluidly connected to the first refrigerant/coolant heat exchanger 9 via the third port 13c as an outlet with the expansion function, the third port 13c as an outlet enables a direct fluid connection to the suction side of the refrigerant circuit 2-1, 2-2 and thus a bypass flow path around the first refrigerant/coolant heat exchanger 9 and the third refrigerant/air heat exchanger 7 with the associated second expansion member 8. Instead of the first 3/2 way valve 13 with an expansion function, individual valves with the corresponding functionalities can also be employed as an alternative.

Furthermore, the refrigerant circuit 2-1, 2-2 respectively has an accumulator 17 which is connected to a suction side of the compressor 3 at an outlet. The suction-side refrigerant lines respectively from the outlet of the third refrigerant/air heat exchanger 7 operated as an evaporator and the first refrigerant/coolant heat exchanger 9 and the second port 13b of the first 3/2 way valve 13 are connected to one another upstream of an inlet of the accumulator 17 via the first opening point 12 and the second opening point 15. Thus, the refrigerant can be partially evaporated, evaporated or overheated when respectively flowing through the second refrigerant/air heat exchanger 5, the third refrigerant/air heat exchanger 7 arranged within the first air flow channel 60 of the air-conditioner and the first refrigerant/coolant heat exchanger 9.

The refrigerant circuit 2-1, 2-2 enables a respective parallel operation of the second refrigerant/air heat exchanger 5 and the first refrigerant/coolant heat exchanger 9 at different pressure levels of the refrigerant. If necessary, the second refrigerant/air heat exchanger 5 and the first refrigerant/coolant heat exchanger 9 can also be operated such that refrigerant flows through them serially. The operating mode can be flexibly adapted to the environmental conditions or the operating conditions, such as temperature and available heat sources of the motor vehicle.

The refrigerant circuit 2-1, 2-2 respectively also has a fourth refrigerant/air heat exchanger 18 operated as an evaporator and a fifth refrigerant/air heat exchanger 20 operated as an evaporator respectively for cooling down or de-humidifying the incoming air of a rear section of the passenger compartment and a fourth expansion member 19 upstream of the fourth refrigerant/air heat exchanger 18 and a fifth expansion member 21 upstream of the fifth refrigerant/air heat exchanger 20. The fourth refrigerant/air heat exchanger 18 with the fourth expansion member 19 is arranged within a first flow path 22 and the fifth refrigerant/air heat exchanger 20 with the fifth expansion member 21 is arranged within a second flow path 23, which respectively extend from a third branching point 24 to a fourth opening point 25 and can be charged with refrigerant in parallel. The fourth opening point 25 is connected to a fifth opening point 26-1, 26-2 via a refrigerant line. The fifth opening point 26-1 of the refrigerant circuit 2-1 of the system 1-1 of FIG. 1A is arranged between the third refrigerant/air heat exchanger 7 and the compressor 3, in particular in the flow direction of the refrigerant upstream of the accumulator 17, specifically between the second opening point 15 and the first opening point 12, while the fifth opening point 26-2 of the refrigerant circuit 2-2 of the system 1-2 of FIG. 1B is arranged between the outlet of the accumulator 17 and the inlet of the compressor 3. In particular, the fourth expansion member 19 and the fifth expansion member 21 are respective expansion valves. The expansion members 6, 8, 10, 19, 21 can respectively be formed as an expansion valve which can be closed.

The third branching point 24 is connected to a second 3/2 way valve 27 formed as a connection point via a refrigerant line. The second 3/2 way valve 27 has three ports 27a, 27b, 27c. A first port 27a is formed as an inlet, a second port 27b is formed as an outlet and a third port 27c is formed as an inlet and an outlet of the second 3/2 way valve 27. The first port 27a of the second 3/2 way valve 27 is arranged as an inlet between the first refrigerant/air heat exchanger 4 operated as a condenser/gas cooler and the first expansion member 6 of the second refrigerant/air heat exchanger 5, in particular the first branching point 11, while the second port 27b of the second 3/2 way valve 27 is connected to the third branching point 24 as an outlet. The third port 27c of the second 3/2 way valve 27, which serves as an inlet or an outlet depending on the operation mode, is arranged between the second refrigerant/air heat exchanger 5, in particular the second branching point 14, and the second expansion member 8 of the third refrigerant/air heat exchanger 7.

While in such a way, the first refrigerant/air heat exchanger 4 can be connected to the fourth refrigerant/air heat exchanger 18 or the fifth refrigerant/air heat exchanger 20 with the second 3/2 way valve 27 via the first port 27a as an inlet and the second port 27b as an outlet, as an alternative, the second refrigerant/air heat exchanger 5 can also be connected to the fourth refrigerant/air heat exchanger 18 or the fifth refrigerant/air heat exchanger 20 with the second 3/2 way valve 27 via the third port 27c as an inlet and the second port 27b as an outlet. Instead of the second 3/2 way valve 27, individual shut-off valves can also be employed as an alternative.

The refrigerant circuit 2-1, 2-2 also respectively has a second refrigerant/coolant heat exchanger 28 operated as a condenser/gas cooler which is arranged in the flow direction of the refrigerant upstream of the first refrigerant/air heat exchanger 4, which is also operated as a condenser/gas cooler, and thus between the compressor 3 and the first refrigerant/air heat exchanger 4. In the second refrigerant/coolant heat exchanger 28, heat is transferred from the refrigerant circulating in the refrigerant circuit 2-1, 2 2 to a coolant circulating in a coolant circuit. The second refrigerant/coolant heat exchanger 28 can be formed as a thermal connection of the refrigerant circuit 2-1, 2-2 to the coolant circuit, in which the first refrigerant/coolant heat exchanger 9 is integrated as well. Alternatively, the second refrigerant/coolant heat exchanger 28 can also represent a thermal connection of the refrigerant circuit 2-1, 2-2 to a second coolant circuit which is different from the first coolant circuit with the first refrigerant/coolant heat exchanger 9.

The coolant circuit or the coolant circuits serve to control the temperature, in particular to cool or to heat the battery or components of the electric drive train and to air-condition the passenger compartment, in particular to heat the incoming air of the passenger compartment.

A respective third 3/2 way valve 29 with three ports 29a, 29b, 29c formed as a branching point is arranged within the refrigerant circuit 2-1, 2-2 between the compressor 3 and the second refrigerant/coolant heat exchanger 28. A first port 29a is formed as an inlet and a second port 29b and a third port 29c are respectively formed as an outlet of the third 3/2 way valve 29. The first port 29a of the third 3/2 way valve 29 is connected to the outlet of the compressor 3 as an inlet, while the second port 29b of the second 3/2 way valve 27 is connected to the second refrigerant/coolant heat exchanger 28 as an outlet. The second refrigerant/coolant heat exchanger 28 is arranged within a flow path extending between the third 3/2 way valve 29 as branching point up to a sixth opening point 30. The sixth opening point 30 is formed upstream of the inlet of the first refrigerant/air heat exchanger 4 in the flow direction of the refrigerant.

The third 3/2 way valve 29 is also connected to the sixth opening point 30 via the third port 29c so that a bypass flow path around the second refrigerant/coolant heat exchanger 28 is provided between the third port 29c of the third 3/2 way valve 29 and the sixth opening point 30. In order to prevent a backflow of refrigerant at the sixth opening point 30 to the second refrigerant/coolant heat exchanger 28 when charging the bypass flow path with refrigerant, a backflow device 31, in particular a backflow valve, is arranged within the flow path with the second refrigerant/coolant heat exchanger 28. Instead of the third 3/2 way valve 29, individual shut-off valves can also be employed as an alternative.

Apart from the respective refrigerant circuit 2-1, 2-2, the system 1-1, 1-2 has thermal heat exchangers 50, 51, 52 for heating the incoming air flowing into the passenger compartment, which can respectively be formed as a refrigerant/air heat exchanger and thus as components of a coolant circuit, in particular of the one coolant circuit or the first coolant circuit or the second coolant circuit. Furthermore, an additional thermal heat exchanger 53 formed as an electric PTC heater can be provided.

A first thermal heat exchanger 50 with the third refrigerant/air heat exchanger 7 operated as an evaporator for cooling down or de-humidifying the incoming air of the passenger compartment and the first refrigerant/air heat exchanger 4 operated as a condenser/gas cooler for heating the incoming air of the passenger compartment is arranged within the first air flow channel 60 of the air-conditioner of the motor vehicle. The first thermal heat exchanger 50 is positioned downstream of the first refrigerant/air heat exchanger 4 in the flow direction of the incoming air of the passenger compartment.

Further, a second thermal heat exchanger 51 for heating the incoming air of the rear section of the passenger compartment is arranged within a second air flow channel 61 of the air-conditioner of the motor vehicle next to the fourth refrigerant/air heat exchanger 18 operated as an evaporator for cooling down or de-humidifying the incoming air of the rear section of the passenger compartment, while a third thermal heat exchanger 52 for heating the incoming air of the rear section of the passenger compartment is arranged within a third air flow channel 62 of the air-conditioner next to the fifth refrigerant/air heat exchanger 20 operated as an evaporator for cooling down or de-humidifying the incoming air of the rear section of the passenger compartment. The thermal heat exchangers 51, 52 are positioned in the flow direction of the incoming air of the passenger compartment respectively downstream of the refrigerant/air heat exchanger 18, 20.

The additional thermal heat exchanger 53 serves to heat the coolant of the coolant circuit in which the second thermal heat exchanger 51 and the third thermal heat exchanger 52 are integrated if not enough heat is transferred to the coolant in the second refrigerant/coolant heat exchanger 28.

The refrigerant circuit 2-1, 2-2 is respectively formed with different sensors, in particular pressure/temperature sensors 41, 42 and temperature sensors 43, 44. A first pressure/temperature sensor 41 is provided at the outlet of the compressor 3 in order to determine the high pressure and the outlet temperature of the refrigerant on the compressor 3. A second pressure/temperature sensor 42 is arranged in the flow direction of the refrigerant downstream of the third refrigerant/air heat exchanger 7 operated as an evaporator in order to determine the low pressure and the outlet temperature of the refrigerant at the third refrigerant/air heat exchanger 7 and thus the overheating of the refrigerant. A first temperature sensor 43 is provided at the outlet of the first refrigerant/air heat exchanger 4, while a second temperature sensor 44 is arranged at the outlet of the first refrigerant/coolant heat exchanger 9 operated as an evaporator.

Hereinafter, different operating modes of the system 1-1 with the refrigerant circuit 2-1 of FIG. 1A are described. Active components of the refrigerant circuit 2-1 are connected to one another via highlighted connection lines. In contrast to the active components, non-active components are shown via thinly represented connection lines. No refrigerant flows through the thinly represented connection lines.

The regions of the refrigerant circuit 2-1 through which refrigerant at different pressure levels flows are to be distinguished from one another with solid and dashed double lines. The solid double lines show the regions of the refrigerant circuit 2-1 through which refrigerant at high pressure level flows, while the dashed double lines show the regions of the refrigerant circuit 2-1 through which refrigerant at low pressure level flows.

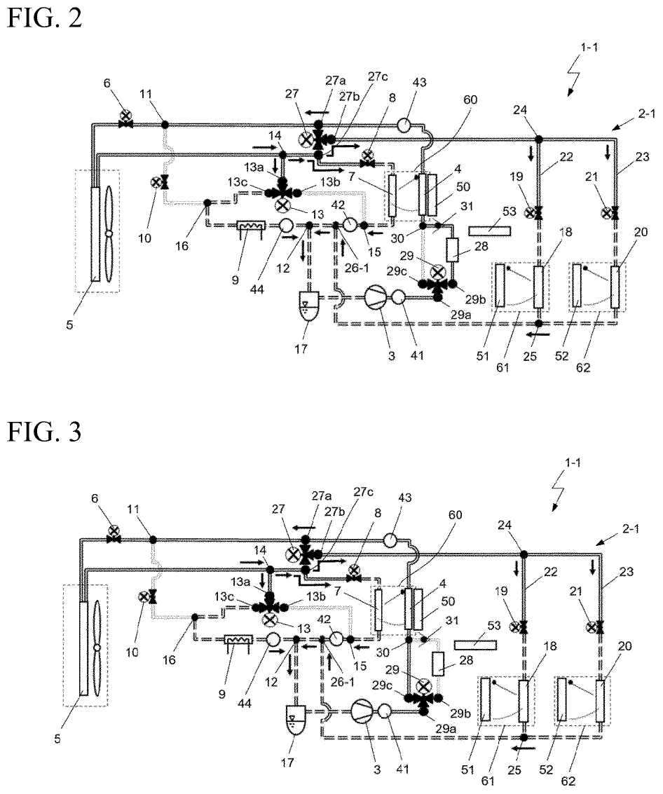

When operating the first system 1-1 with the refrigerant circuit 2-1 of FIG. 1A in a first refrigeration plant mode for cooling and/or de-humidifying the incoming air of the passenger compartment of FIG. 2, the first port 29a of the third 3/2 way valve 29 is connected to the second port 29b so that the refrigerant flowing out of the compressor 3 at high pressure level is guided to the second refrigerant/coolant heat exchanger 28 operated as a condenser/gas cooler. When flowing through the second refrigerant/coolant heat exchanger 28, the refrigerant is at least de-heated and partially liquefied or cooled down. The heat is transferred from the refrigerant to the coolant circulating in the coolant circuit.

The refrigerant then flows through the backflow device 31 and the first refrigerant/air heat exchanger 4 arranged within the first air flow channel 60 of the air-conditioner, which is not charged with incoming air, through to the first expansion member 6 and the second refrigerant/air heat exchanger 5 operated as a condenser/gas cooler. The first expansion member 6 is fully opened so that the refrigerant at the high pressure level flows into the second refrigerant/air heat exchanger 5. When flowing through the second refrigerant/air heat exchanger 5, the refrigerant is fully liquefied and undercooled or cooled down. The heat is transferred from the refrigerant to the ambient air. In addition to the second refrigerant/air heat exchanger 5, the second refrigerant/coolant heat exchanger 28 serves an additional heat dissipation from the refrigerant.

The supercooled refrigerant flowing out of the second refrigerant/air heat exchanger 5 is divided into a first partial mass flow to the first 3/2 way valve 13 with an expansion function at the second branching point 14 and a second partial mass flow to the second 3/2 way valve 27. The first partial mass flow of the refrigerant, when flowing through the first 3/2 way valve 13 from the first port 13a formed as an inlet to the third port 13c formed as an outlet, is relaxed to low pressure level and then guided to the first refrigerant/coolant heat exchanger 9. The third expansion member 10 is closed. When flowing through the first refrigerant/coolant heat exchanger 9, the refrigerant is evaporated and optionally overheated. The heat is transferred from the coolant circulating in the coolant circuit to the refrigerant circulating in the refrigerant circuit 2 1. The coolant can serve the active cooling of the battery of the motor vehicle.

A third partial mass flow of the refrigerant is branched off from the second partial mass flow guided to the second 3/2 way valve 27 in the region of the second 3/2 way valve 27. The second partial mass flow is relaxed to the low pressure level when flowing through the second expansion member 8 and is then guided to the third refrigerant/air heat exchanger 7. The second partial mass flow of the refrigerant through the third refrigerant/air heat exchanger 7 operated as an evaporator is regulated by means of the second expansion member 8.

When flowing through the third refrigerant/air heat exchanger 7, the refrigerant is evaporated and optionally overheated. The heat is transferred from the incoming air of the passenger compartment guided through the first air flow channel 60 to the refrigerant circulating in the refrigerant circuit 2 1. The incoming air is cooled down and optionally de-humidified and then flowed out into the front section of the passenger compartment. The first partial mass flow and the second partial mass flow of the refrigerant are mixed with each other at the first opening point 12 and introduced into the accumulator 17.

The third partial mass flow of the refrigerant is guided from the third port 27c operated as an inlet to the second port 27b of the second 3/2 way valve 27 formed as an outlet within any pressure change. Then, a fourth partial mass flow of the supercooled refrigerant at high pressure level is branched off from the third partial mass flow at the third branching point 24. The third partial mass flow of the refrigerant flowing through the first flow path 22 is relaxed to the low pressure level while flowing through the fourth expansion member 19 and guided to the fourth refrigerant/air heat exchanger 18, while the fourth partial mass flow of the refrigerant flowing through the second flow path 23 is relaxed to the low pressure level while flowing through the fifth expansion member 21 and guided to the fifth refrigerant/air heat exchanger 20. The third partial mass flow and the fourth partial mass flow of the refrigerant are guided through the flow paths 22, 23 in parallel. The third partial mass flow of the refrigerant through the fourth refrigerant/air heat exchanger 18 operated as an evaporator and the fourth partial mass flow of the refrigerant through the fifth refrigerant/air heat exchanger 20 operated as an evaporator are regulated correspondingly by means of the fourth expansion member 19 and the fifth expansion member 21.

When flowing through the fourth refrigerant/air heat exchanger 18 and the fifth refrigerant/air heat exchanger 20, the refrigerant is respectively evaporated and optionally overheated. The heat is respectively transferred to the refrigerant circulating in the refrigerant circuit 2-1 from the incoming air of the passenger compartment guided through the second air flow channel 61 and guided through the third air flow channel 62. The incoming air is respectively cooled down and optionally de-humidified and then flowed out into the rear section of the passenger compartment. The third partial mass flow and the fourth partial mass flow of the refrigerant are mixed with each other at the fourth opening point 25 and guided to the fifth opening point 26-1 as the third partial mass flow. At the fifth opening point 26-1, the third partial mass flow is mixed with the second partial mass flow, which is then guided to the first opening point 12 as the second partial mass flow and at the first opening point 12, mixed with the first partial mass flow, flows into the accumulator 17. The evaporator 3 draws in the refrigerant from the accumulator 17.

When operating the first system 1-1 with the refrigerant circuit 2-1 of FIG. 1A in a second refrigeration plant mode for cooling and/or de-humidifying the incoming air of the passenger compartment of FIG. 3, the first port 29a of the third 3/2 way valve 29, compared to the operation in the first refrigeration plant mode of FIG. 2, is connected to the third port 29c, so that the refrigerant flowing out of the compressor 3 at high pressure level is directly guided to the first refrigerant/air heat exchanger 4 which is not charged with incoming air. The refrigerant is guided through the first refrigerant/air heat exchanger 4 to the first expansion member 6 and the second refrigerant/air heat exchanger 5 operated as a condenser/gas cooler. The first expansion member 6 is fully opened so that the refrigerant at the high pressure level flows into the second refrigerant/air heat exchanger 5. When flowing through the second refrigerant/air heat exchanger 5, the refrigerant is de-heated, fully liquefied completely and optionally undercooled or cooled down. The heat is transferred from the refrigerant to the ambient air. The second refrigerant/coolant heat exchanger 28 is not charged with refrigerant.

Otherwise, the operation of the first system 1-1 with the refrigerant circuit 2-1 in the second refrigeration plant mode corresponds to the operation of the first system 1-1 with the refrigerant circuit 2-1 in the first refrigeration plant mode of FIG. 2, so that reference is made to the explanations for FIG. 2.

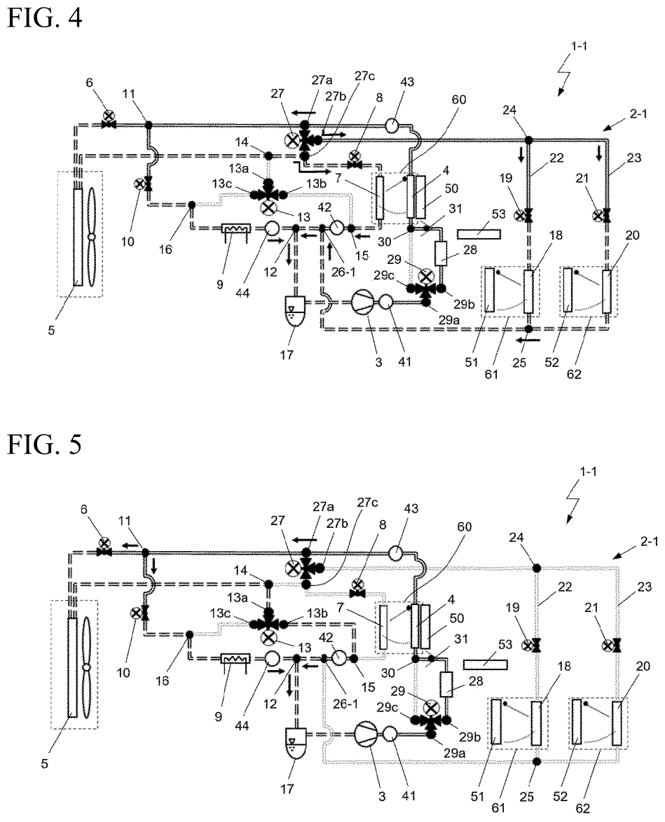

FIG. 4 reveals the first system 1-1 of FIG. 1A during the operation of the refrigerant circuit 2-1 in a post-heating mode for de-humidifying and optionally cooling and post-heating the incoming air of the passenger compartment. The first port 29a of the third 3/2 way valve 29 is connected to the second port 29b, so that the refrigerant flowing out of the compressor 3 at high pressure level is guided to the second refrigerant/coolant heat exchanger 28 operated as a condenser/gas cooler. When flowing through the second refrigerant/coolant heat exchanger 28, the refrigerant is at least de-heated and partially liquefied or cooled down. The heat is transferred from the refrigerant to the coolant circulating in the coolant circuit. The heated coolant can be guided through the thermal heat exchangers 51, 52 for heating the incoming air for the rear section of the passenger compartment.

The refrigerant then flows through the backflow device 31 and the first refrigerant/air heat exchanger 4 arranged within the first air flow channel 60 of the air-conditioner. When flowing through the first refrigerant/air heat exchanger 4, the refrigerant is fully liquefied and undercooled or cooled down. The heat is transferred from the refrigerant to the incoming air for the front section of the passenger compartment. In doing so, the incoming air, which was at least de-humidified before, is heated.

After flowing out of the first refrigerant/air heat exchanger 4, the refrigerant is divided into a first partial mass flow and a second partial mass flow in the region of the second 3/2 way valve 27. The first partial mass flow is guided to the first branching point 11. A third partial mass flow of the refrigerant is branched off from the first partial mass flow at the first branching point 11.

The first partial mass flow is guided through the first expansion member 6 to the second refrigerant/air heat exchanger 5 operated as a condenser/gas cooler. When flowing through the first expansion member 6, the first partial mass flow of the refrigerant is relaxed to a medium pressure level or the low pressure level as required. When flowing through the second refrigerant/air heat exchanger 5, the refrigerant is at least partially evaporated. The heat is transferred from the ambient air to the refrigerant. The first partial mass flow of the refrigerant is then guided to the second expansion member 8. When flowing through the second expansion member 8, the first partial mass flow of the refrigerant is relaxed from the medium pressure level to the low pressure level or the first partial mass flow of the refrigerant flows through the second expansion member 8 at the same low pressure level while the second expansion member 8 is fully opened. The first partial mass flow of the refrigerant is then guided to the third refrigerant/air heat exchanger 7 operated as an evaporator.

When flowing through the third refrigerant/air heat exchanger 7, the first partial mass flow of the refrigerant is evaporated and optionally overheated. The heat is transferred from the incoming air of the passenger compartment guided through the first air flow channel 60 to the refrigerant circulating in the refrigerant circuit 2 1. The incoming air is de-humidified and optionally cooled down and then, when flowing through the first refrigerant/air heat exchanger 4, heated and flowed out into the front section of the passenger compartment.

When flowing through the third expansion member 10, the third partial mass flow of the refrigerant is relaxed to the low pressure level and then guided to the first refrigerant/coolant heat exchanger 9. The first 3/2 way valve 13 is fully closed. When flowing through the first refrigerant/coolant heat exchanger 9, the refrigerant is evaporated and optionally overheated. The heat is transferred from the coolant circulating in the coolant circuit to the refrigerant circulating in the refrigerant circuit 2 1. The coolant can serve the active cooling of the battery of the motor vehicle or receive waste heat from components of the electric drive train.

The first partial mass flow and the third partial mass flow of the refrigerant are mixed with each other at the first opening point 12 and introduced into the accumulator 17.

The second partial mass flow of the supercooled refrigerant at high pressure level branched off in the region of the second 3/2 way valve 27 is guided from the first port 27a operated as an inlet to the second port 27b of the second 3/2 way valve 27 formed as an outlet without any pressure change. Then, a fourth partial mass flow of the refrigerant is branched off from the second partial mass flow at the third branching point 24. The second partial mass flow of the refrigerant flowing through the first flow path 22 is relaxed to the low pressure level while flowing through the fourth expansion member 19 and guided to the fourth refrigerant/air heat exchanger 18, while the fourth partial mass flow of the refrigerant flowing through the second flow path 23 is relaxed to the low pressure level when flowing through the fifth expansion member 21 and guided to the fifth refrigerant/air heat exchanger 20. The second partial mass flow and the fourth partial mass flow of the refrigerant are guided through the flow paths 22, 23 in parallel. The second partial mass flow of the refrigerant through the fourth refrigerant/air heat exchanger 18 operated as an evaporator and the fourth partial mass flow of the refrigerant through the fifth refrigerant/air heat exchanger 20 operated as an evaporator are regulated correspondingly by means of the fourth expansion member 19 and the fifth expansion member 21.

When flowing through the fourth refrigerant/air heat exchanger 18 and the fifth refrigerant/air heat exchanger 20, the refrigerant is respectively evaporated and optionally overheated. The heat is respectively transferred to the refrigerant circulating in the refrigerant circuit 2-1 from the incoming air of the passenger compartment guided through the second air flow channel 61 and guided through the third air flow channel 62. In doing so, the incoming air is respectively de-humidified and optionally cooled down and, when flowing through the second thermal heat exchanger 51 and the third thermal heat exchanger 52, is heated and then flown out into the rear section of the passenger compartment. The second partial mass flow and the fourth partial mass flow of the refrigerant are mixed with each other at the fourth opening point 25 and guided to the fifth opening point 26-1 as the second partial mass flow. At the fifth opening point 26-1, the first partial mass flow is mixed with the second partial mass flow, which is then guided to the first opening point 12 as the first partial mass flow and at the first opening point 12, mixed with the third partial mass flow, flows into the accumulator 17. The evaporator 3 draws in the refrigerant from the accumulator 17.

In FIG. 5, the first system 1-1 of FIG. 1A is represented during the operation of the refrigerant circuit 2-1 in a heating mode. The first port 29a of the third 3/2 way valve 29 is connected to the second port 29b, so that the refrigerant flowing out of the compressor 3 at high pressure level is guided to the second refrigerant/coolant heat exchanger 28 operated as a condenser/gas cooler. When flowing through the second refrigerant/coolant heat exchanger 28, the refrigerant is at least de-heated and partially liquefied or cooled down. The heat is transferred from the refrigerant to the coolant circulating in the coolant circuit. The heated coolant can be guided through the thermal heat exchangers 51, 52 for heating the incoming air for the rear section of the passenger compartment.

The refrigerant then flows through the backflow device 31 and the first refrigerant/air heat exchanger 4 arranged within the first air flow channel 60 of the air-conditioner. When flowing through the first refrigerant/air heat exchanger 4, the refrigerant is fully liquefied and optionally undercooled or cooled down. The heat is transferred from the refrigerant to the incoming air for the front section of the passenger compartment, which is thus heated.

After flowing out of the first refrigerant/air heat exchanger 4, the refrigerant is guided to the first branching point 11. At the first branching point 11, the mass flow of the refrigerant is divided into a first partial mass flow and a second partial mass flow.

The first partial mass flow is guided through the first expansion member 6 to the second refrigerant/air heat exchanger 5 operated as a condenser/gas cooler. When flowing through the first expansion member 6, the first partial mass flow of the refrigerant is relaxed to the low pressure level. When flowing through the second refrigerant/air heat exchanger 5, the refrigerant is evaporated and optionally overheated. The heat is transferred from the ambient air to the refrigerant. Then, the first partial mass flow of the refrigerant is guided through the second branching point 14 and from the first port 13a to the second port 13b through the first 3/2 way valve 13 without any pressure change.

When flowing through the third expansion member 10, the second partial mass flow of the refrigerant is relaxed to the low pressure level and then guided to the first refrigerant/coolant heat exchanger 9. When flowing through the first refrigerant/coolant heat exchanger 9, the refrigerant is evaporated and optionally overheated. The heat is transferred from the coolant circulating in the coolant circuit to the refrigerant circulating in the refrigerant circuit 2 1. The coolant can serve the active cooling of the battery of the motor vehicle or receive waste heat from components of the electric drive train.

The first partial mass flow and the second partial mass flow of the refrigerant are mixed with each other at the first opening point 12 and introduced into the accumulator 17.

No refrigerant flows through the second 3/2 way valve 27. The second expansion member 8 and the fourth expansion member 19 as well as the fifth expansion member 21 are closed. The third refrigerant/air heat exchanger 7 and the fourth refrigerant/air heat exchanger 18 and the fifth refrigerant/air heat exchanger 20 operable as an evaporator are not charged with refrigerant. A respective liquid refrigerant can be stored, for example, in the refrigerant lines extending from the closed second 3/2 way valve 27, in particular from the second port 27b of the second 3/2 way valve 27, to the third branching point 24 and extending from the third branching point 24 to the fourth expansion member 19 and to the fifth expansion member 21 in order to make the heat pump operation more energy-efficient. The refrigerant lines serve as refrigerant intermediate storage. Thus, the lifetime of the compressor 3 can be maximized and the internal volume of the accumulator 17 can be minimized.

1-23. (canceled)

24. A system to air-condition incoming air of a passenger compartment of a motor vehicle, having a refrigerant circuit comprising:
a compressor,
a first refrigerant/air heat exchanger operable as a condenser/gas cooler for heating the incoming air of the passenger compartment;
a refrigerant path with a second refrigerant/air heat exchanger operable as a condenser/gas cooler or as an evaporator for heat exchange with ambient air with an upstream first expansion member and a third refrigerant/air heat exchanger operable as an evaporator for conditioning the incoming air of the passenger compartment with an upstream second expansion member; and
a refrigerant circuit with a first refrigerant/coolant heat exchanger operable as an evaporator for heat exchange between a coolant for controlling a temperature of at least one component of a drive train of the motor vehicle and a refrigerant with an upstream third expansion member, wherein the refrigerant path with the second refrigerant/air heat exchanger and the third refrigerant/air heat exchanger and a refrigerant path with the first refrigerant/coolant heat exchanger operable as an evaporator respectively extend from a first branching point to a first opening point and are formed such that they can be charged with the refrigerant independently from one another and in parallel to one another, wherein the refrigerant circuit has a first connection point with a first port, a second port and a third port, wherein the first port is arranged between the first refrigerant/air heat exchanger and the first expansion member of the second refrigerant/air heat exchanger and the third port is arranged between the second refrigerant/air heat exchanger and the second expansion member of the third refrigerant/air heat exchanger and a refrigerant path extends from the third port to a second opening point, in a fourth refrigerant/air heat exchanger and a fifth refrigerant/air heat exchanger (operable as an evaporator for conditioning the incoming air of the passenger compartment each with an upstream expansion member is arranged, wherein the second opening point is arranged in a flow direction of the refrigerant upstream of the compressor.

25. The system according to claim 24, wherein the refrigerant path extending from the third port of the first connection point to the second opening point has a first flow path and a second flow path which respectively extend from a second branching point to a third opening point and are formed such that they can be charged with the refrigerant independently from one another and in parallel to one another, wherein the first flow path has a fourth refrigerant/air heat exchanger operable as an evaporator with an upstream fourth expansion member and the second flow path has a fifth refrigerant/air heat exchanger operable as an evaporator with an upstream fifth expansion member.

26. The system according to claim 24, wherein the first branching point of the refrigerant path with the second refrigerant/air heat exchanger and the third refrigerant/air heat exchanger and the refrigerant path with the first refrigerant/coolant heat exchanger operable as the evaporator is arranged between the first refrigerant/air heat exchanger and the first expansion member of the second refrigerant/air heat exchanger.

27. The system according to claim 24, wherein the first opening point of the refrigerant path with the second refrigerant/air heat exchanger and the third refrigerant/air heat exchanger and the refrigerant path with the first refrigerant/coolant heat exchanger operable as the evaporator are arranged in the flow direction of the refrigerant upstream of the compressor.

28. The system according to claim 24, wherein the first connection point is formed as a 3/2 way valve with the first port as an inlet, the second port as an outlet, and the third port as an inlet and an outlet.

29. The system according to claim 24, wherein the refrigerant circuit has an accumulator which is arranged upstream of the compressor in the flow direction of the refrigerant.

30. The system according to claim 29, wherein the second opening point of the refrigerant path extending from the third port of the connection point is arranged between the third refrigerant/air heat exchanger and the compressor.

31. The system according to claim 29, wherein the second opening point of the refrigerant path extending from the third port of the connection point is arranged between the accumulator and the compressor.

32. The system according to claim 24, wherein the refrigerant circuit has a second connection point formed as a 3/2 way valve with an expansion function and with a first port, a second port, and a third port, wherein the first port is formed as an inlet and the second port and the third port are respectively formed as an outlet and the expansion function is formed between the first port and the third port.

33. The system according to claim 32, wherein the first port of the 3/2 way valve is connected to a second branching point arranged between the second refrigerant/air heat exchanger and the second expansion member of the third refrigerant/air heat exchanger, the second port of the 3/2 way valve is connected to an opening point arranged between the third refrigerant/air heat exchanger and the compressor, and the third port of the 3/2 way valve is connected to an opening point arranged between the third expansion member and the first refrigerant/coolant heat exchanger operable as an evaporator.

34. The system according to claim 25, wherein an air-conditioner with a plurality of flow channels is formed, wherein the third refrigerant/air heat exchanger operable as an evaporator for conditioning the incoming air of the passenger compartment and the first refrigerant/air heat exchanger operable as a condenser/gas cooler for heating the incoming air of the passenger compartment are arranged in a flow direction of the incoming air one after the other within a first one of the air flow channels which opens into the passenger compartment in a front section of the passenger compartment, and the fourth refrigerant/air heat exchanger for conditioning the incoming air of the passenger compartment, operable as an evaporator, is arranged within a second one of the air flow channels which opens into the passenger compartment in a rear section of the passenger compartment.

35. The system according to claim 34, wherein the fifth refrigerant/air heat exchanger for conditioning the incoming air of the passenger compartment, operable as an evaporator, is arranged within a third one of the air flow channels which opens into the passenger compartment in the rear section of the passenger compartment.

36. The system according to claim 34, wherein a heat exchanger for heating the incoming air, which is formed as a refrigerant/air heat exchanger or as an electric PTC heater, is arranged within each of the air flow channels in the flow direction of the incoming air downstream of a respective one of the third refrigerant/air heat exchanger, the fourth refrigerant/air heat exchanger, and the fifth refrigerant/air heat exchanger.

37. The system according to claim 24, wherein the refrigerant circuit has a second refrigerant/coolant heat exchanger operable as a condenser/gas cooler and a branching point formed as a 3/2 way valve with a first port, a second port, and a third port, wherein the first port is formed as an inlet and the second port and the third port are respectively formed as an outlet.

38. The system according to claim 37, wherein the first port of the 3/2 way valve is connected to an outlet of the compressor, the second port of the 3/2 way valve is connected to the refrigerant/air heat exchanger operable as a condenser/gas cooler, and the third port of the 3/2 way valve is connected to an opening point arranged in the flow direction of the refrigerant upstream of the first refrigerant/air heat exchanger.

39. The system according to claim 38, wherein the second refrigerant/coolant heat exchanger operable as a condenser/gas cooler is arranged within a flow path extending between the second port of the 3/2 way valve to the opening point arranged upstream of the first refrigerant/air heat exchanger.

40. A method for operating the system for air-conditioning the air of the passenger compartment of the motor vehicle according to claim 24 in a refrigeration plant mode for conditioning, the method comprising steps of:
guiding the refrigerant circulating in the refrigerant circuit and flowing out of the compressor at a high pressure level through the first expansion member to the second refrigerant/air heat exchanger operated as a condenser/gas cooler and transferring heat from the refrigerant at the high pressure level to the ambient air, wherein the first expansion member is fully opened and the refrigerant, when flowing through the second refrigerant/air heat exchanger, is fully liquefied and supercooled or cooled down;
guiding the refrigerant flowing out of the second refrigerant/air heat exchanger to the first connection point formed as a 3/2 way valve;
dividing the refrigerant into a partial mass flow through the third refrigerant/air heat exchanger operated as an evaporator with the second expansion member and a partial mass flow through the refrigerant path extending from the third port of the 3/2 way valve to the second opening point with the fourth refrigerant/air heat exchanger and the fifth refrigerant/air heat exchanger each operated as an evaporator each with the upstream expansion member;
relaxing the partial mass flow through the third refrigerant/air heat exchanger and the partial mass flow through the refrigerant path extending from the third port of the 3/2 way valve to the second opening point to a low pressure level when flowing through the second expansion member and the upstream expansion member and guiding the partial mass flows to a respective one of the third refrigerant/air heat exchanger, the fourth refrigerant/air heat exchanger, and the fifth refrigerant/air heat exchanger;
evaporating and optionally overheating the partial mass flows when flowing through the respective one of the third refrigerant/air heat exchanger, the fourth refrigerant/air heat exchanger, and the fifth refrigerant/air heat exchanger, wherein respective heat is transferred from the incoming air of the passenger compartment guided through a plurality of air flow channels to the refrigerant, wherein the incoming air is cooled down and/or de-humidified and respectively flows out of the air flow channels into a front section of the passenger compartment and a rear section of the passenger compartment; and
mixing the partial mass flows of the refrigerant in the flow direction of the refrigerant upstream of the compressor and drawing the refrigerant through the compressor.

41. The method according to claim 40, wherein the partial mass flow of the refrigerant guided through the refrigerant path extending from the third port of the 3/2 way valve to the second opening point is divided into a partial mass flow through a first flow path and a partial mass flow through a second flow path, wherein the partial mass flow flowing through the first flow path and the partial mass flow flowing through the second flow path are relaxed to the low pressure level when respectively flowing through the upstream expansion member and are evaporated and optionally overheated when flowing through the fourth refrigerant/air heat exchanger and the fifth refrigerant/air heat exchanger, wherein respective heat is transferred from the incoming air of the passenger compartment guided through one of the air flow channels to the refrigerant, wherein the incoming air is respectively cooled down and/or de-humidified and flows out of the air flow channels into the rear section of the passenger compartment, and wherein the partial mass flows of the evaporated and optionally overheated refrigerant are mixed with one another.

42. The method according to claim 40, wherein the refrigerant flowing out of the second refrigerant/air heat exchanger is divided into a partial mass flow to the connection point formed as a 3/2 way valve and a partial mass flow to a 3/2 way valve with an expansion function, wherein the partial mass flow guided to the 3/2 way valve with an expansion function, when flowing through the 3/2 way valve, relaxes to the low pressure level and, when flowing through the first refrigerant/coolant heat exchanger operated as an evaporator, is evaporated and optionally overheated, wherein heat from the coolant circulating in a coolant circuit is transferred to the refrigerant circulating in the refrigerant circuit, and the partial mass flows of the refrigerant are mixed with one another before being drawn in by the compressor.

43. The method according to claim 40, wherein the refrigerant flowing out of the compressor at the high pressure level is guided to a second refrigerant/coolant heat exchanger operated as a condenser/gas cooler, wherein the refrigerant, when flowing through the second refrigerant/coolant heat exchanger, is at least de-heated and partially liquefied or cooled down and the heat is transferred from the refrigerant to the coolant circulating in a coolant circuit.

44. A method for operating the system for air-conditioning the air of the passenger compartment of the motor vehicle according to claim 24 in a post-heating mode for conditioning, the method comprising steps of:
guiding the refrigerant circulating in the refrigerant circuit and flowing out of the compressor at a high pressure level to a second refrigerant/coolant heat exchanger operated as a condenser/gas cooler and transferring heat from the refrigerant to the coolant circulating in a coolant circuit, wherein the refrigerant, when flowing through the second refrigerant/coolant heat exchanger, is at least de-heated and partially liquefied or cooled down, wherein the heated coolant is guided through thermal heat exchangers charged with the incoming air for heating the previously de-humidified and optionally cooled down incoming air for a rear section of the passenger compartment,
guiding the refrigerant flowing out of the second refrigerant/coolant heat exchanger operated as a condenser/gas cooler to the first refrigerant/air heat exchanger and transferring heat from the refrigerant at the high pressure level to the incoming air for a front section of the passenger compartment, wherein the refrigerant, when flowing through the first refrigerant/air heat exchanger, is fully liquefied and supercooled or cooled down and the previously de-humidified and optionally cooled down incoming air is heated,
guiding the refrigerant flowing out of the first refrigerant/air heat exchanger to the first connection point formed as a 3/2 way valve, and
dividing the refrigerant into a partial mass flow through the second refrigerant/air heat exchanger operated as an evaporator with the first expansion member and a partial mass flow through the refrigerant path extending from the third port of the 3/2 way valve to the second opening point with the fourth refrigerant/air heat exchanger and the fifth refrigerant/air heat exchanger each operated as an evaporator each with the upstream expansion member,
relaxing the partial mass flow of the refrigerant guided to the second refrigerant/air heat exchanger to a medium pressure level or a low pressure level when flowing through the first expansion member and guiding the partial mass flow through the second refrigerant/air heat exchanger operated as an evaporator, wherein the refrigerant is at least partially evaporated and the heat is transferred from ambient air to the refrigerant, and guiding the partial mass flow of the refrigerant flowing out of the second refrigerant/air heat exchanger to the third refrigerant/air heat exchanger operated as an evaporator with the second expansion member and relaxing the partial mass flow to a low pressure level when flowing through the second expansion member and guiding the partial mass flow to the third refrigerant/air heat exchanger operated as an evaporator,
relaxing the partial mass flow of the refrigerant guided through the refrigerant path extending from the third port of the 3/2 way valve to the second opening point with the fourth refrigerant/air heat exchanger and the fifth refrigerant/air heat exchanger each operated as an evaporator each with the upstream expansion member to the low pressure level when flowing through a respective one of the upstream expansion member and guiding the partial mass flow to the fourth refrigerant/air heat exchanger and the fifth refrigerant/air heat exchanger each operated as an evaporator,
evaporating and optionally overheating the partial mass flows of the refrigerant when flowing through the respective one of the third refrigerant/air heat exchanger, the fourth refrigerant/air heat exchanger, and the fifth refrigerant/air heat exchanger, wherein respective heat is transferred from the incoming air of the passenger compartment guided through the air flow channels to the refrigerant, wherein the incoming air is cooled down and/or de-humidified, wherein the incoming air flowing through the first refrigerant/air heat exchanger is heated and flows out into the front section of the passenger compartment and the incoming air flowing through the thermal heat exchangers is heated and flows out into the rear section of the passenger compartment, and
mixing the partial mass flows of the refrigerant and drawing the refrigerant through the compressor.

45. The method according to claim 44, wherein the partial mass flow of the refrigerant guided through the refrigerant path extending from the third port of the 3/2 way valve to the second opening point is divided into a partial mass flow through a first flow path and a partial mass flow through a second flow path, wherein the partial mass flow flowing through the first flow path and the partial mass flow flowing through the second flow path are relaxed to the low pressure level when respectively flowing through the upstream expansion member and are evaporated and optionally overheated when flowing through the fourth refrigerant/air heat exchanger and the fifth refrigerant/air heat exchanger, wherein respective heat is transferred from the incoming air of the passenger compartment guided through one of the air flow channels to the refrigerant, wherein the incoming air is respectively cooled down and/or de-humidified, is heated when flowing through the thermal heat exchangers and flows out of the air flow channels into the rear section of the passenger compartment, and wherein the partial mass flows of the vaporous and optionally overheated refrigerant are mixed with one another.

46. The method according to claim 44, wherein the partial mass flow of the refrigerant guided to the second refrigerant/air heat exchanger operated as an evaporator with the first expansion member is divided into a partial mass flow to the first expansion member and a partial mass flow to the first refrigerant/coolant heat exchanger operated as an evaporator with the third expansion member, wherein the partial mass flow guided to the first refrigerant/coolant heat exchanger operated as an evaporator relaxes to the low pressure level when flowing through the third expansion member and is evaporated and optionally overheated when flowing through the first refrigerant/coolant heat exchanger, wherein heat is transferred from the coolant circulating in the coolant circuit to the refrigerant circulating in the refrigerant circuit, and the partial mass flows of the refrigerant are mixed with one another before being drawn in by the compressor.
